(19) United States
(12) Patent Application Publication
(10) Pub. No.: US 2008/0085451 A1
(43) Pub. Date: Apr. 10, 2008

(54) Highly Compact Electrochemical Cell

(75) Inventors: Gary Freitag, East Aurora, NY (US); Dominick Frustaci, Williamsville, NY (US)

Correspondence Address: GREATBATCH LTD, 10,000 Whrie Drive, CLARENCE, NY, 14031, US

(73) Assignee: Greatbatch Ltd., Clarence, NY (US)

(21) Appl. No.: 11/868,593

(22) Filed: Oct. 8, 2007

Related U.S. Application Data
(60) Provisional application No. 60/828,398, filed on Oct. 6, 2006.

(51) Int. Cl. H01M 2/02; B22F 3/02

(52) U.S. Cl. 429/174; 29/623.2; 419/66; 429/179

(57) ABSTRACT

A highly compact electrochemical cell comprised of a casing having a proximal opening, a distal opening, and an intermediate sidewall surrounding an enclosed volume. A glass-to-metal seal is disposed in the proximal opening and within the enclosed volume of the casing, and a terminal pin extends from outside the casing through the glass-to-metal seal into the enclosed casing volume. An insulator is disposed along the casing sidewall. A cathode is contained within the insulator in electrical contact with the terminal pin. A separator disc is disposed contiguously with the casing sidewall and in contact with the cathode. An anode is provided in contact with the separator disc and with the casing sidewall opposite the cathode. An electrolyte is provided within the cell, and a lid is sealed to the casing to hermetically enclose the cell contents.

### CROSS-REFERENCE TO RELATED PATENT APPLICATION

This application claims priority from U.S. provisional patent application Ser. No. 60/828,398, filed Oct. 6, 2006.

### BACKGROUND OF THE INVENTION

1. Field of the Invention

The present invention relates generally to electrochemical cells. More particularly, the present invention relates in one embodiment to a highly miniaturized electrochemical cell suitable for integration into an implantable or exploratory medical device. The cell is sufficiently small to be suitable for delivery as part of the medical device through the vasculature of a human.

2. Description of Related Art

Recent advances in electrochemical cell technology have resulted in cells that have high discharge rate capability and high energy density. These cells are sufficiently compact in size to render them suitable for use in implantable medical devices such as cardiac pacemakers and defibrillators.

U.S. Patent Application Pub. No. 2007/0122697 to Wutz et al., which is assigned to the assignee of the present invention and incorporated herein by reference, describes one such exemplary electrochemical cell comprising a substantially rectangular casing, and a mating terminal connector adapted to be connected to the ferrule and the conductive terminal pin of the cell. The terminal connector is provided for easily and quickly connecting the cell to a circuit board of the kind found in an implantable medical device, such as a cardiac pacemaker, defibrillator, neuro-stimulator, or drug pump.

Although the cell of Wutz et al. is suitable for use with many implantable medical devices, continuing medical advances are driving a need for even smaller cells that may be used in more compact implantable devices or in exploratory medical devices that may be deployed into the human vasculature, digestive tract, lungs, or other tissues. Cells such as that of Wutz et al. are too large to be used in these applications.

What is needed, therefore, is an electrochemical cell that is further miniaturized, and is readily connectable to a correspondingly miniaturized medical device. In order to produce such a compact cell, new cell design concepts are needed that eliminate or combine components to the greatest extent possible. New component and cell manufacturing processes are also needed to produce compact cells.

### SUMMARY OF THE INVENTION

The present invention meets the above needs by providing a highly compact electrochemical cell comprised of a casing having a proximal opening, a distal opening, and a sidewall surrounding an enclosed volume. A glass-to-metal seal is disposed in the proximal opening with a terminal pin extending from outside the casing through the glass-to-metal seal and into the enclosed volume of the casing. An insulator is disposed along a first portion of the casing sidewall. A cathode comprising cathode active material is contained within the insulator and in electrical contact with the terminal pin. A separator disc is disposed contiguously with a second portion of the casing sidewall and in contact with the cathode. An anode comprising anode active material is provided in contact with the separator disc and with a third portion of the casing sidewall. An electrolyte is provided within the cell to activate the anode and the cathode, and a lid is sealed to the distal opening of the casing to hermetically enclose the cell contents.

The casing may have a cylindrical shape, a rectangular shape, or a prismatic shape. The casing sidewall may include a narrowed region that is contiguous with the glass-to-metal seal. The insulator is formed as a bag having a sidewall and a bottom through which the proximal end of the terminal pin protrudes. An elastomeric material joins the insulator bottom to the glass-to-metal seal. The insulator further includes an outer edge in contact with a separator disc that closes the insulator bag opposite its bottom. The cathode active material is preferably silver vanadium oxide provided in a powdered form.

The cell lid, which closes the distal casing opening opposite the glass-to-metal seal, includes a protrusion that is in an interference contact with the anode. The lid protrusion extends from the base of the lid and is embedded in the anode active material. That way, the lid applies a compressive force against the anode, the separator disc, and the cathode.

The compact electrochemical cell is connectable to a correspondingly small medical device. The medical device may be an implantable device, or an exploratory medical device that is deployed into the human vasculature, digestive tract, lungs, and other tissues for a shorter time than that of typical implantable devices. In accordance with the invention there is also provided a medical device including the cell of the present invention.

The cell is preferably connected to the medical device at the proximal casing opening. The cell also includes a flange at the proximal casing opening where connection to the device is made.

In accordance with the present invention, a method for making a compact electrochemical cell is also provided comprising the steps of forming a casing comprising a proximal opening, a distal opening, and a sidewall surrounding an enclosed volume; sealing a terminal pin within a glass-to-metal seal disposed in the proximal opening and within the enclosed volume of the casing; inserting an insulator within the enclosed volume along a first portion of the casing sidewall; forming a cathode by placing cathode active material within the insulator and in electrical contact with the terminal pin; placing a separator disc contiguously with a second portion of the casing sidewall and in contact with the cathode; contacting the separator disc and the cathode with an electrolyte; forming an anode by placing anode active material in contact with the separator disc opposite the cathode and with a third portion of the casing sidewall; and sealing the distal end of the casing with a lid.

The method may include joining the insulator to the glass-to-metal seal with an elastomeric material. The cathode active material may be provided as a powder, and the cathode formed by pressing the powder. The casing lid may include a protrusion, with the method further comprising placing the protrusion in interfering contact with the anode. The method may also include placing the anode, the separator disc, and the cathode in compression with the lid.

The foregoing and additional objects, advantages, and characterizing features of the present invention will become increasingly more apparent upon a reading of the following detailed description together with the included drawings.

### BRIEF DESCRIPTION OF THE DRAWINGS

The present invention will be described by reference to the following drawings, in which like numerals refer to like elements, and in which:

FIG. 1 is a perspective view of a casing of a compact electrochemical cell of the invention;

FIG. 2 is a cross-sectional view taken along line 2-2 of FIG. 1;

FIG. 3 is a cross-sectional view of the casing of FIG. 2 with a glass-to-metal seal joined thereto, and also showing the joining of the casing to a medical device;

FIG. 4 is a cross-sectional view of an alternative casing of the compact cell including a flange at the proximal opening thereof, and showing the joining of the casing to a medical device at the flange;

FIG. 5 is a cross-sectional view of the cell casing in an inverted position, and with an elastomeric material dispensed on the glass-to-metal seal;

FIG. 6 is a cross-sectional view of the partially fabricated cell with an insulator bag fitted therein and joined to the glass-to-metal seal by the elastomeric material;

FIG. 7 is a cross-sectional view of the partially fabricated cell with the insulator bag filled with powdered cathode active material;

FIG. 8 is a cross-sectional view of the partially fabricated cell with the cathode active material compressed to form the cathode, and with a separator disc placed within the casing in contact with the cathode;

FIG. 9 is a cross-sectional view of the partially fabricated cell with anode active material disposed above the separator disc;

FIG. 10 is a cross-sectional view of the partially fabricated cell with the lid placed over the distal opening of the casing and applying compression to the anode, separator disc, and cathode; and

FIG. 11 is a cross-sectional view of the completed of cell fabrication, with the lid being welded and sealed to the distal casing opening.

The present invention will be described in connection with a preferred embodiments, however, it should be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION OF THE PREFERRED EMBODIMENTS

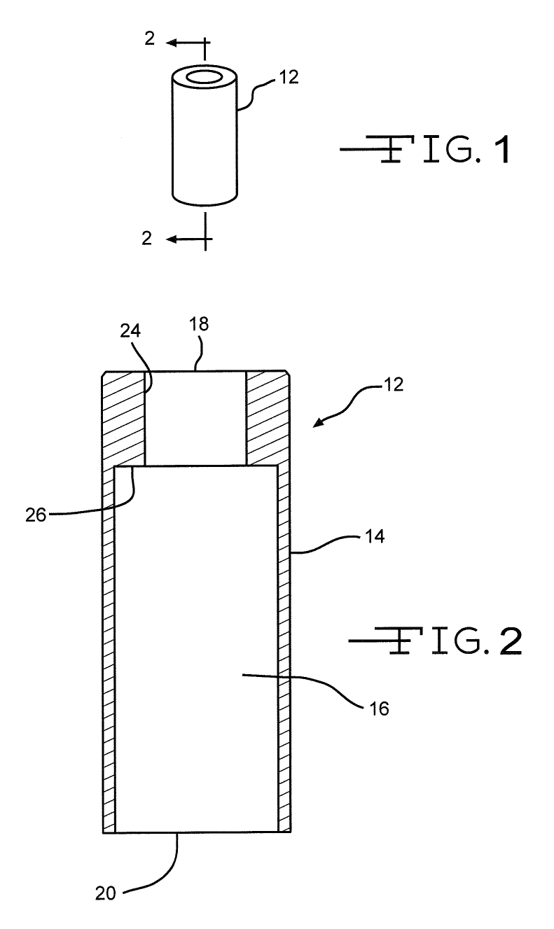

Turning now to the drawings, FIG. 11 is a perspective view of an electrochemical cell 10 including a casing 12 (FIG. 1) comprised of a sidewall 14 surrounding an enclosed volume 16. The casing 12 has a proximal opening 18 and a distal opening 20 at the respective ends of the sidewall 14. The casing sidewall 14 may have a cylindrical shape, a rectangular shape, a prismatic shape, or certain other irregular shapes that can be made by the processes used to make cell casings. The casing 12 is made of metal, such as stainless steel, titanium, nickel, aluminum, or other suitable electrically conductive materials. One preferred casing material is titanium.

In a typical prior art electrochemical cell used to power an implantable medical device, the casing is stamped or deep drawn to its final shape and mated and sealed to a lid or a second case half. However, these forming processes cannot achieve the dimensions and tolerances required for the highly compact cells of the present invention. In one embodiment of the present invention, the casing 12 of FIG. 1 is cylindrically shaped with a diameter of 0.5 cm, a length of 1.25 cm, and a volume of less than 0.25 cm³. A stamping or deep drawing process is not suitable for forming such a casing at the required tolerances.

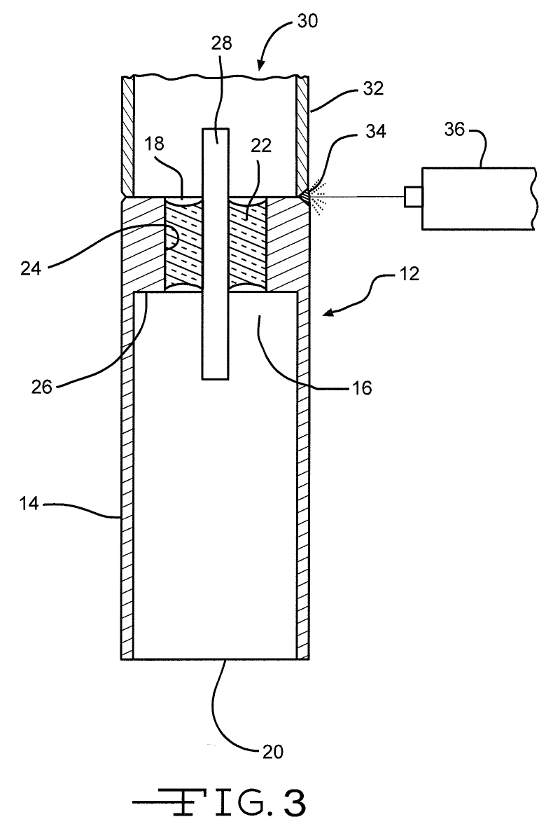

To produce such a casing 12 according to the present invention, a short piece of cylindrical rod stock is chemically and/or physically machined to a final shape such as that shown in FIGS. 1 and 2. Suitable machining processes include mechanical lathe turning/boring, electrical discharge machining, electroforming, laser machining, and the like. These processes are advantageous over the conventional stamping or deep drawing case fabrication processes, because more precise internal and external tolerances can be achieved. Additionally, machining the casing 12 does not produce internal stresses that a stamping process may cause. Stresses or micro-fractures in stamped or drawn casings of the size required for the present invention are susceptible to corrosion cracking, which can lead to loss of hermeticity through the casing wall and failure of the cell.

Referring also to FIG. 3, a glass-to-metal seal (GTMS) 22 is disposed in the proximal opening 18 and within the enclosed volume 16 of the casing 12. In one preferred embodiment, casing side wall 14 includes a narrowed region 24 that is contiguous with the GTMS 22. In that manner, the diameter of the GTMS 22 may be less than the inside diameter (or other cross section) of the casing 12, making it less susceptible to failure. However, in embodiments in which the diameter of the casing 12 is sufficiently small, the narrowed region 24 is not necessary, and the GTMS 22 may be bonded directly to the inner surface of the casing sidewall 14. Additionally, it will be apparent that when a narrowed region 24 is provided, the formed shoulder 26 may have a shape other than perpendicular to the casing sidewall 14 (as shown in FIG. 3), depending upon the machining process used to make the casing 12.

A terminal pin 28 extends from outside the casing through the proximal opening 18 and into the enclosed volume 16 of the casing 12. The terminal pin 28 forms an annular space within the narrowed region 24. The GTMS 22 is formed within this annulus, and provides a hermetic seal between the terminal pin 28 and the casing 12. The terminal pin 32 is of molybdenum, aluminum, nickel alloy, or stainless steel, the former being preferred. The sealing glass in GTMS 22 is of a corrosion resistant type having up to about 50% by weight silicon such as CABAL 12, TA 23, FUSITE 425 or FUSITE 435.

The compact electrochemical cell 10 is connectable to a correspondingly small medical device. The medical device may be an implantable device, or an exploratory medical device that may be deployed into the human vasculature, digestive tract, lungs, or other tissues. Referring again to FIG. 3, the cell is preferably connected to the medical device 30 at the proximal opening 18 of the cell casing 12. In one embodiment, the cell casing 12 is joined and hermetically sealed to the housing 32 of the medical device 30 by weld 34, which may be formed by scanning a laser welding device 36 around the perimeter of the junction between the medical device 30 and the casing 12.

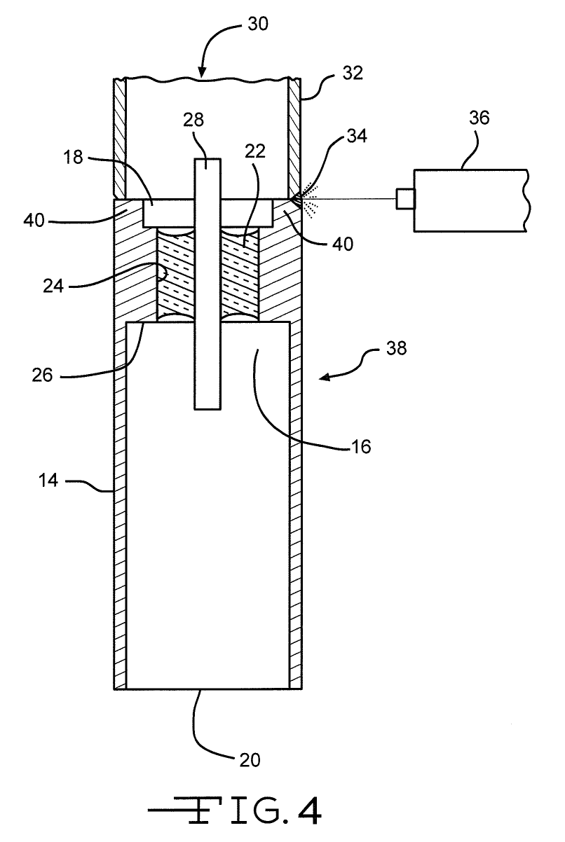

FIG. 4 is a cross-sectional view of an alternative casing 38 of the compact cell, including a flange 40 at the proximal opening 18 thereof. By providing flange 40 integral with the casing 38, the distance between the weld 34 and the GTMS 22 and other internal components is increased. In that manner, the amount of heat that is conducted into such components is reduced and thermal damage to the cell components during welding is avoided. It will be apparent that although the joining of either one of the casings 12 or 38 to the medical device 30 is shown in FIGS. 3 and 4 as occurring prior to the completion of cell fabrication, such joining may be performed after fabrication of the cell 10 of FIG. 11 is completed.

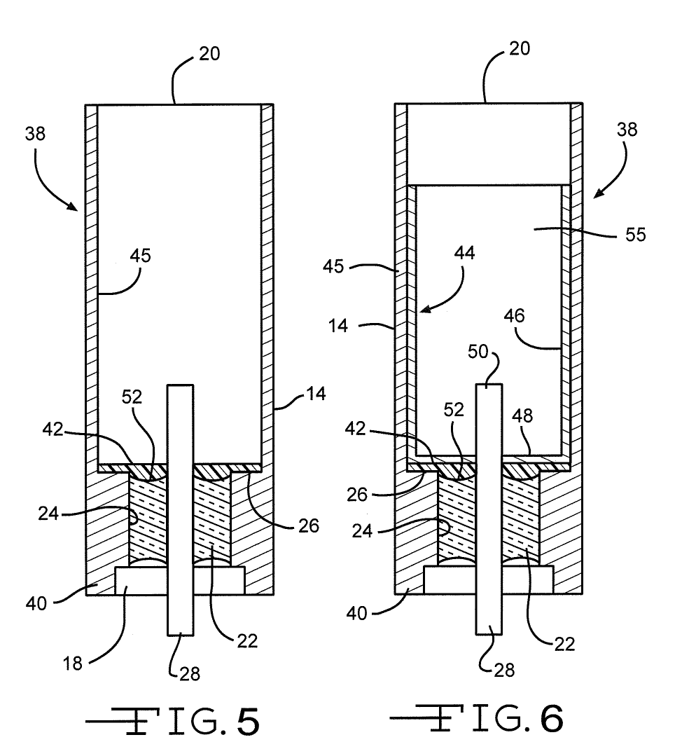

FIG. 5 is a cross-sectional view of the cell casing 38 in an inverted position. In one preferred embodiment, a liquid elastomeric material 42 is dispensed on the glass-to-metal seal 22, and on the shoulder 26 of the narrowed region 24 of the casing 38, if the narrowed region 24 is provided. The elastomeric material 42 is preferably a polysiloxane that cures to a solid at room temperature.

Referring also to FIG. 6, prior to allowing the elastomeric material to cure to a solid, an insulator 44 is inserted into the casing 38 along a first portion 45 of the casing sidewall 14 and seated onto the elastomeric material 42. The insulator 44 can be of any of the hereinafter discussed materials that are suitable for the separator, although it is preferably of polyethylenetetrafluoroethylene (ETFE). A separator is of a material that permits ionic flow there through while maintaining physical separation between the opposite polarity active materials. Likewise, the insulator must maintain physical segregation between the anode and the cathode, but it does not need to permit ionic flow because the casing sidewall is directly opposite the cathode active material contained inside it, as will be discussed presently.

The insulator 44 is preferably formed as a bag having a sidewall 46 and a bottom 48, through which the proximal end 50 of the terminal pin 28 protrudes. Alternatively, insulator 44 can be formed as a sleeve, with its inner edge seated into the elastomeric material 42. Use of the elastomeric material 42 is preferred because it fills any small void formed between the terminal pin and the casing at the inner surface 52 of the GTMS 22. The elastomeric material also seals any gap that is present between the terminal pin and the insulator, thereby allowing for greater positional and size variability of the through hole in the bag bottom 48, if such is provided. In that manner, loose particles of cathode active material are prevented from bypassing the insulator and making contact with the casing.

Referring to FIG. 11, cell 10 is preferably built in a case negative design with the casing 12 serving as the anode terminal. However, the cell can also be built in a case-positive design. In that respect, the electrode 54 would be the anode and the other electrode 56 would be the cathode. Both the case-negative and case-positive electrode designs are well known by those skilled in the art.

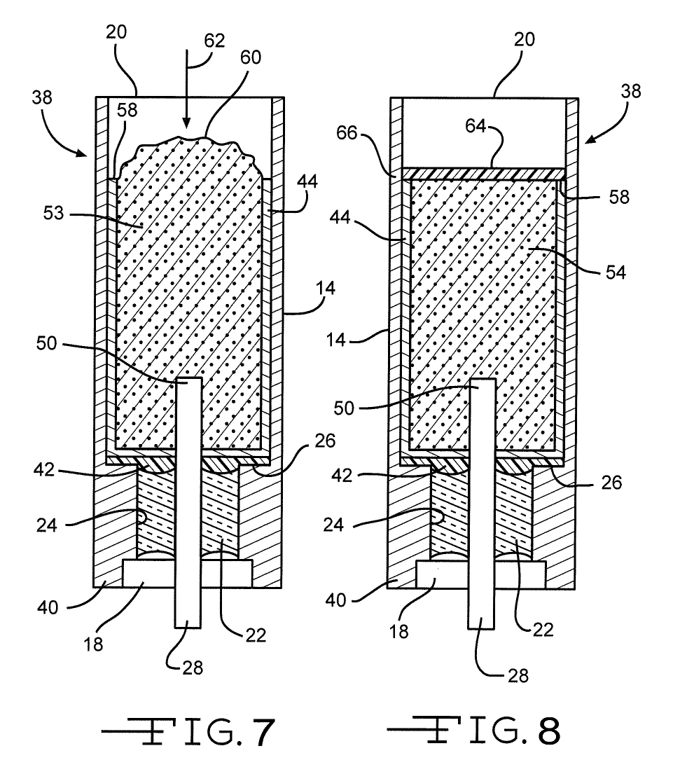

Turning now to the preferred case-negative cell design, and referring to FIG. 7, the cathode of the cell is shown being formed. In one preferred embodiment, a quantity of cathode active material 53, such as silver vanadium oxide in a powdered form, is filled into the volume 55 (FIG. 6) within the insulator 44 until it is mounded up beyond the upper edge 58 thereof. The mound 60 of cathode active material 53 is then compressed further into the casing 14 using a piston (not shown) or other suitable tool as indicated by arrow 62. The cathode active material 53 is then pressed until its upper surface is substantially coplanar with the upper edge 58 of the insulator 44. The cathode active material 53 is also in electrical contact with the proximal end 50 of the terminal pin 28.

Other cathode active materials that are useful with the present invention include copper silver vanadium oxide (CSVO), V₂O₅, MnO₂, LiCoO₂, LiNiO₂, LiMn₂O₄, TiS₂, Cu₂S, FeS, FeS₂, copper oxide, copper vanadium oxide, Ag₂O, Ag₂O₂, CuF₂, Ag₂CrO₄, MnO₂, and mixtures thereof. In any event, the cathode active material is typically formed into a mixture of about 1% to 5% of a conductive diluent and about 1% to 5% of a binder material, by weight, prior to being used in the cell. Suitable conductive diluents include acetylene black, carbon black and/or graphite. Metals such as nickel, aluminum, titanium and stainless steel in powder form are also useful as conductive diluents.

A suitable binder material is preferably a thermoplastic polymeric material. The term thermoplastic polymeric material is used in its broad sense and any polymeric material which is inert in the cell and which passes through a thermoplastic state, whether or not it finally sets or cures, is included within the term “thermoplastic polymer”. Representative binder materials include polyethylene, polypropylene, polyimide, and fluoropolymers such as fluorinated ethylene, fluorinated propylene, polyvinylidene fluoride (PVDF), and polytetrafluoroethylene (PTFE). Natural rubbers are also useful as the binder material with the present invention.

Referring to FIG. 8, a separator disc 64 is next disposed contiguously with a second portion 66 of the side wall 14 of the casing 38 and in contact with the cathode 54. The separator disc 64 is also preferably abutted against the upper edge 58 of the insulator 44, and is in an interference fit with the casing sidewall 14. In that manner, the separator disc 64 seals against the sidewall 14 and the insulator 44, thereby preventing any cathode active material from contacting the casing 38. The separator disc 64 is of electrically insulative material that is chemically unreactive with the anode and cathode active materials and both chemically unreactive with and insoluble in the electrolyte that is subsequently added to the cell. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetra-fluoroethylene, and polyethylenechlorotrifluoroethylene used either alone or laminated with a fluoropolymeric microporous film, non-woven glass, polypropylene, polyethylene, glass fiber materials, ceramics, polytetrafluoroethylene membrane commercially available under the designation ZITEX (Chemplast Inc.), polypropylene membrane commercially available under the designation CELGARD (Celanese Plastic Company, Inc.), a membrane commercially available under the designation DEXIGLAS (C. H. Dexter, Div., Dexter Corp.), and a membrane commercially available under the designation TONEN®.

A small quantity of electrolyte (not shown) is then dispensed onto the separator disc 64, permeating and wetting the cathode 54 and the separator disc 64. In order to saturate the cathode 54 and separator disc 64, the electrolyte may be delivered in multiple aliquots. A suitable electrolyte has an inorganic, ionically conductive salt dissolved in a nonaqueous solvent, and more preferably, the electrolyte includes an ionizable lithium salt dissolved in a mixture of aprotic organic solvents comprising a low viscosity solvent and a high permittivity solvent. The inorganic, ionically conductive salt serves as the vehicle for migration of the anode ions to intercalate or react with the cathode active materials. Known lithium salts that are useful as a vehicle for transport of alkali metal ions from the anode to the cathode include LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof.

Suitable low viscosity solvents invention include esters, linear and cyclic ethers and dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, diethyl carbonate, dipropyl carbonate, and mixtures thereof, and suitable high permittivity solvents include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone (GBL), N-methyl-pyrrolidinone (NMP), and mixtures thereof. The preferred electrolyte for a lithium anode is 0.8M to 1.5M LiAsF₆ or LiPF₆ dissolved in a 50:50 mixture, by volume, of propylene carbonate as the preferred high permittivity solvent and 1,2-dimethoxyethane as the preferred low viscosity solvent.

Referring to FIG. 9, the anode of the cell is next formed. In one preferred embodiment, a pre-formed slug 66 of anode active material is inserted into the casing 14. The slug may be cylindrical as shown in the drawings, or spherical in shape. A preferred anode active material is lithium. The slug is preferably provided with a diameter that is at or near the inside diameter of casing 38.

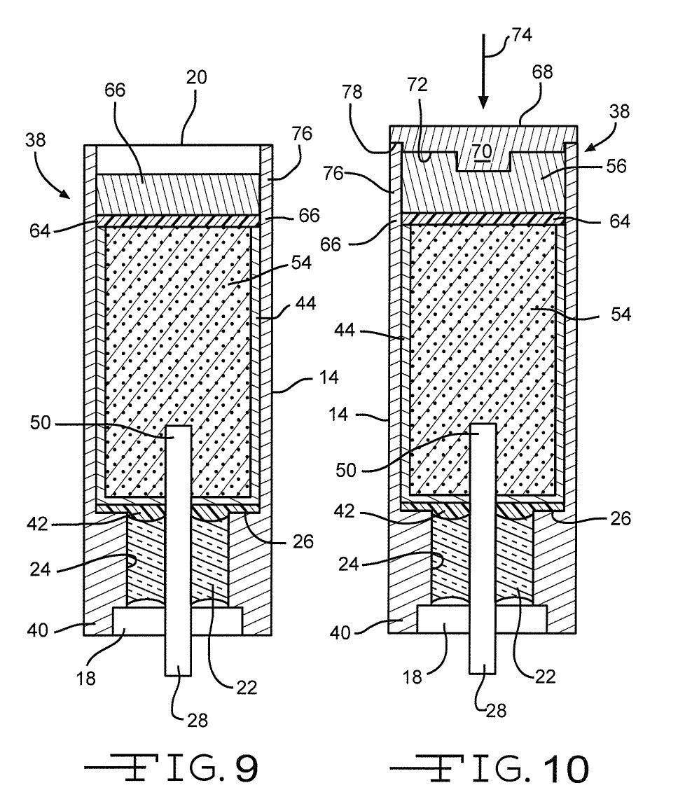

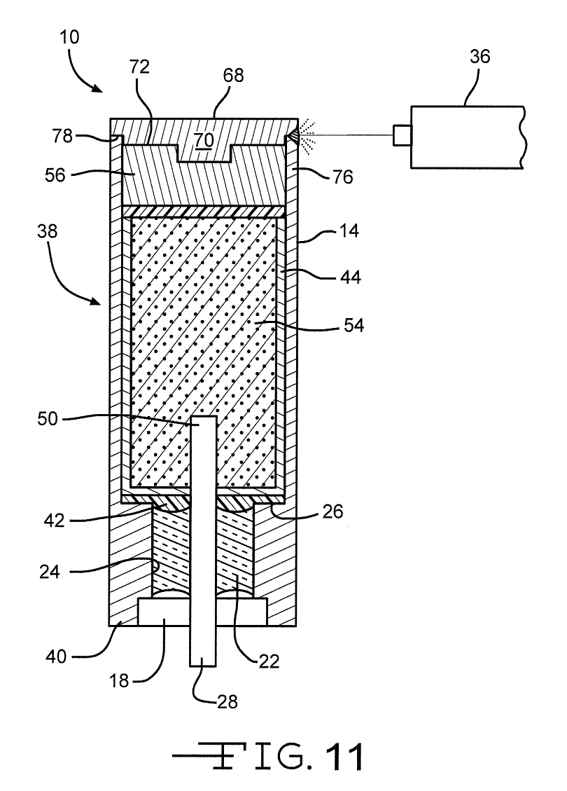

Referring to FIG. 10, the lid 68 of the cell is then seated on the distal casing opening 20. The lid 68 preferably includes a protrusion 70 extending from the lower surface 72 thereof, such that the lid 68 can be forced (per arrow 74) against anode slug 66 into an interference fit therewith. Anode active material 66 may be a malleable material that undergoes plastic deformation and flows within the remaining volume of the casing 38. The dimensions of the casing 38, the lid protrusion 70, and the anode slug 66 are selected such that when the lid 68 is fully seated on the casing 38, the anode slug has deformed into contact with the separator disc 64 and a third portion 76 of casing side wall 14. Forcing of the lid protrusion 70 against anode 56 preferably causes the lithium to completely fill the remaining available space within the casing 38, and also places the anode 56, the separator disc 64, and the cathode 54 in compression against each other. In that manner, electron and ion transport between the anode 56 and the cathode 54 through the separator disc 64 is facilitated.

Lid 68 is preferably made of the same metal as casing 38. Suitable metals include stainless steel, titanium, nickel, aluminum, with titanium being preferred. The lid protrusion 70 extends to a position short of being in contact with separator disc 64 as shown in FIG. 10. It will be apparent that protrusion 70 may be provided in other shapes, such as a conical shape, or a truncated conical shape. Lid 68 may be further provided with a shoulder 78, which provides an improved fit to the distal opening 20 of the casing 38.

Turning finally to FIG. 11, the lid 68 is sealed to the distal casing opening 20 to hermetically enclose the contents of the cell 10. In one preferred embodiment, a laser 36 is used to weld the lid 68 to the casing 38.

A compact electrochemical cell according to the present invention was fabricated with a titanium casing and lid as shown in FIG. 11. The casing had an outside diameter of about 2.34 millimeters (mm), a length of about 5.69 mm, and a side wall thickness of about 0.15 mm. The casing had a narrowed region of about 1.27 mm in diameter and about 1.17 mm in length within which a glass-to-metal seal was formed. The terminal pin was of molybdenum having a diameter of about 0.38 mm. The cathode comprised a mixture of, by weight, about 941 silver vanadium oxide, 3% graphite as a conductive diluent and about 3% PTFE binder filled to a depth of about 3.30 mm. The anode was of lithium having a height of about 0.76 mm. Direct physical contact between the anode and cathode was prevented by an intermediate TONEN separator. The electrolyte comprised 1.0M LiAsF₆ dissolved in a 50:50 mixture, by volume, of propylene carbonate and 1,2-dimethoxyethane.

Thus, the highly compact electrochemical cell 10 of the present invention is advantageous over other cell designs for several reasons. The cell 10 is simplified in construction. Non-active components such as the anode and cathode current collector screens, certain insulators, and an electrolyte fill plug that are typical of prior art cells have been eliminated. The manufacturing steps to provide these in the cell are also eliminated, thereby lowering cell cost and increasing manufacturing throughput.

It is, therefore, apparent that there has been provided, in accordance with the present invention, a highly compact electrochemical cell, and a method for making the cell. While this invention has been described in conjunction with preferred embodiments thereof, it is evident that many alternatives, modifications, and variations will be apparent to those skilled in the art. Accordingly, the present invention is intended to embrace all such alternatives, modifications and variations that fall within the broad scope of the appended claims.

What is claimed is:

1. An electrochemical cell comprised of:
a) a casing comprising a proximal opening, a distal opening, and a sidewall surrounding an enclosed volume;
b) a glass-to-metal seal disposed in the proximal opening and within the enclosed volume of the casing;
c) a terminal pin extending from outside the casing through the proximal opening and through the glass-to-metal seal into the enclosed volume of the casing;
d) an insulator disposed along a first portion of the casing sidewall;
e) a cathode comprising cathode active material contained within the insulator and in electrical contact with the terminal pin;
f) a separator disc contiguous with a second portion of the casing sidewall and in contact with the cathode;
g) an anode comprising anode active material in contact with the separator disc and with a third portion of the casing sidewall;
h) a lid sealed to the distal opening of the casing; and
i) an electrolyte activating the anode and the cathode.

2. The cell of claim 1 wherein the casing is of a cylindrical shaped.

3. The cell of claim 1 wherein the casing is of a rectangular shaped.

4. The cell of claim 1 wherein the casing sidewall is comprised of a narrowed region contiguous with the glass-to-metal seal.

5. The cell of claim 1 further comprising an elastomeric material that joins the insulator to the glass-to-metal seal.

6. The cell of claim 5 wherein the insulator is formed as a bag having a sidewall and a bottom, and wherein the bottom is joined to the glass-to-metal seal by the elastomeric material.

7. The cell of claim 1 wherein the insulator includes an outer edge and the separator disc is in contact with the outer separator edge.

8. The cell of claim 1 wherein the lid comprises a protrusion in an interference fit with the anode.

9. The cell of claim 8 wherein the protrusion is embedded in the anode active material.

10. The cell of claim 1 wherein the lid applies a compressive force to the anode, the separator disc, and the cathode.

11. The cell of claim 1 further comprising a flange at the proximal casing opening that is connectable to an implantable medical device.

12. The cell of claim 1 wherein the casing is made of titanium.

13. The cell of claim 1 wherein the cathode is formed by pressing a powder of cathode active material.

14. The cell of claim 1 wherein the cathode active material is selected from the group consisting of silver vanadium oxide, copper silver vanadium oxide, V₂O₅, MnO₂, LiCoO₂, LiNiO₂, LiMn₂O₄, TiS₂, Cu₂S, FeS, FeS₂, copper oxide, copper vanadium oxide, Ag₂O, Ag₂O₂, CuF₂, Ag₂CrO₄, MnO₂, and mixtures thereof.

15. The cell of claim 1 wherein the anode active material is lithium.

16. The cell of claim 1 wherein the electrolyte is comprised of at least one lithium salt selected from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆FSO₃, LiO₂CCF₃, LiSO₆F, LiB(C₆H₅)₄, LiCF₃SO₃, and mixtures thereof dissolved in at least one solvent selected from the group consisting of tetrahydrofuran, methyl acetate, diglyme, triglyme, tetraglyme, dimethyl carbonate, 1,2-dimethoxyethane, 1,2-diethoxyethane, 1-ethoxy, 2-methoxyethane, ethyl methyl carbonate, methyl propyl carbonate, ethyl propyl carbonate, diethyl carbonate, dipropyl carbonate, propylene carbonate, ethylene carbonate, butylene carbonate, acetonitrile, dimethyl sulfoxide, dimethyl formamide, dimethyl acetamide, γ-valerolactone, γ-butyrolactone, N-methyl-pyrrolidinone, and mixtures thereof.

17. An implantable medical device powered by an electrochemical cell, the electrochemical cell comprising:
a) a casing comprising a proximal opening joined to the medical device housing, a distal opening, and a sidewall surrounding an enclosed volume;
b) a glass-to-metal seal disposed proximate to the proximal opening and within the enclosed volume of the casing;
c) a terminal pin extending from outside the casing through the proximal opening and through the glass-to-metal seal into the enclosed volume of the casing;
d) an insulator disposed along a first portion of the casing sidewall;
e) a cathode comprising cathode active material contained within the insulator and in electrical contact with the terminal pin;
f) separator disc contiguous with a second portion of the casing sidewall and in contact with the cathode;
h) an anode comprising anode active material in contact with the separator disc and with a third portion of the casing sidewall;
i) a lid sealed to the distal opening of the casing; and
j) an electrolyte activating the anode and the cathode.

18. A method of making an electrochemical cell comprising the steps of:
a) forming a casing comprising a proximal opening, a distal opening, and a sidewall surrounding an enclosed volume;
b) sealing a terminal pin within a glass-to-metal seal disposed in the proximal opening and within the enclosed volume of the casing;
c) inserting an insulator within the enclosed volume along a first portion of the casing sidewall;
d) forming a cathode by placing cathode active material within the insulator and in electrical contact with the terminal pin;
e) placing a separator disc contiguously with a second portion of the casing sidewall and in contact with the cathode;
f) contacting the separator disc and the cathode with an electrolyte;
g) forming an anode by placing anode active material in contact with the separator disc and with a third portion of the casing sidewall; and
h) sealing the distal end of the casing with a lid.

19. The method of claim 18 further comprising joining the insulator to the glass-to-metal seal with an elastomeric material.

20. The method of claim 18 including providing the cathode active material as a powder and forming the cathode by pressing the powder.

21. The method of claim 18 further comprising placing the anode, the separator disc, and the cathode in compression with the lid.

22. The method of claim 18 wherein the lid is comprised of a protrusion, and the method further comprising the step of placing the protrusion in interfering contact with the anode.
